(19) United States
(12) Patent Application Publication
(10) Pub. No.: US 2025/0292372 A1
(43) Pub. Date: Sep. 18, 2025

(54) METHOD, COMPUTER DEVICE, AND RECORDING MEDIUM TO PREVENT LEARNING TO PROTECT IMAGES

(71) Applicant: NAVER WEBTOON Ltd., Seongnam-si (KR)

(72) Inventors: Namhyuk AHN, Seongnam-si (KR); Seung-Hun NAM, Seongnam-si (KR); Wonhyuk AHN, Seongnam-si (KR)

(73) Assignee: NAVER WEBTOON Ltd., Seongnam-si (KR)

(21) Appl. No.: 19/071,060

(22) Filed: Mar. 5, 2025

(30) Foreign Application Priority Data
Mar. 12, 2024 (KR) 10-2024-0034761

(51) Int. Cl. G06T 5/60; G06T 11/60

(52) U.S. Cl. CPC G06T 5/60; G06T 11/60; G06T 2207/20081; G06T 2207/20084

(57) ABSTRACT

Disclosed are a learning prevention methods, a computer device configured to perform the learning prevention method, and a recording medium storing instructions to perform the learning protection methods may be provided. The learning prevention method may include generating a perceptual map for an original image, the perceptual map representing perceptual sensitivity to perturbation for the original image, and inserting the perturbation into the original image based on the perceptual map to generate a result image for learning prevention.

### CROSS-REFERENCE TO RELATED APPLICATION(S)

This U.S. non-provisional application and claims the benefit of priority under 35 U.S.C. § 119 to Korean Patent Application No. 10-2024-0034761, filed Mar. 12, 2024, the entire contents of which are incorporated herein by reference in its entirety.

### BACKGROUND

### Technical Field

Some example embodiments relate to technology that may block or prevent unauthorized use of copyrighted data during a learning process of a generative artificial intelligence (AI) model.

### Related Art

Currently, technology for generating images by incorporating artificial intelligence (AI) has been growing significantly. As multimedia technology and computer technology develop, image generation technology using a deep learning method is being developed.

For example, a virtual image may be generated using a generative adversarial network (GAN)-based deep learning model.

With the growing impact of an image-based generative AI model (e.g., diffusion model) that newly produces similar content using the existing content, the issue of copyright protection for a creation used in a model learning process is attracting attention.

### SUMMARY

Some example embodiments provide learning prevention technology that may block or prevent imitation of styles of copyrighted data used without permission in a learning process of an image-based generative artificial intelligence (AI) model.

According to at least one example embodiment, there is provided a learning prevention method of a computer device including at least one processor. The learning prevention method includes generating, by the at least one processor, a perceptual map for an original image, the perceptual map representing perceptual sensitivity to perturbation for the original image, and inserting, by the at least one processor, the perturbation into the original image based on the perceptual map to generate a result image for learning prevention.

According to an aspect, the generating of the perceptual map may include generating a plurality of just noticeable difference (JND) images through different JND calculation methods for the original image, and generating the perceptual map for perception-aware protection using the plurality of JND images.

According to another aspect, the generating of the perceptual map may include generating the perceptual map for perception-aware protection using a plurality of noticeable difference (JND) images, the plurality of JND images generated from the original image through different calculation methods, and generating the perceptual map through a weighted sum of the plurality of JND images according to by assigning different weights to the plurality of JND images, respectively.

According to still another aspect, the learning prevention method may further include determining each of the weights based on the original image. each of the weights being a learnable parameter that adjusts contribution of a corresponding one of the plurality of JND images.

According to still another aspect, the learning prevention method may further include updating each of the weights together in a process of updating the perturbation.

According to still another aspect, the generating of the perceptual map may include generating the perceptual map for perception-aware protection using a plurality of just noticeable difference (JND) images, the plurality of JND images generated from the original image using different calculation methods, and generating the perceptual map through spatial averaging for the plurality of JND images.

According to still another aspect, the generating of the result image for the learning prevention may include generating the result image for preventing learning of a generative AI by inserting the perturbation into the original image according to the perceptual map.

According to still another aspect, the learning prevention method may further include maintaining, by the at least one processor, quality of the result image based on a difference with the original image.

According to still another aspect, the maintaining of the quality of the result image may include maintaining image quality similar to the original image within a perceptual constraint through a perceptual constraint pool configured with at least one latent model.

According to still another aspect, the maintaining of the quality of the result image may include projecting the result image onto a latent space through a latent model, and calculating a difference with the original image in the latent space.

According to at least one example embodiment, there is provided a non-transitory computer-readable recording medium storing instructions that, when executed by a processor, cause a computer device including the processor to perform the aforementioned learning prevention method.

According to at least one example embodiment, there is provided a computer device including at least one processor configured to execute computer-readable instructions and cause the computer device to generate a perceptual map for an original image, the perceptual map representing perceptual sensitivity to perturbation for the original image, and insert the perturbation into the original image based on the perceptual map to generate a result image for learning prevention.

According to some example embodiments, it is possible to provide a learning-prevented creation by inserting subtle perturbation into an original creation to block or prevent unauthorized use of a creation in a learning process of a generative AI model.

According to some example embodiments, by suppressing subtle perturbation that is inserted into an original creation as much as possible and by adjusting the perturbation strength based on perturbation sensitivity of the creation, it is possible to improve the quality of a learning-prevented creation without compromising a learning prevention performance.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of a computer device according to at least one example embodiment;

FIG. 3 illustrates an example for describing an overview of blocking or preventing learning of generative artificial intelligence (AI) according to at least one example embodiment;

FIG. 4 is a flowchart illustrating an example of a learning prevention method that may be performed by a computer device according to at least one example embodiment;

FIG. 5 illustrates an overview of a learning prevention model according to at least one example embodiment;

FIG. 6 illustrates an algorithm of a learning prevention technique according to at least one example embodiment;

FIGS. 7 to 9 illustrate an example of calculating a perceptual map according to at least one example embodiment; and

FIG. 10 illustrates an example of advancing the quality of a learning-prevented image according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated example embodiments. Rather, the illustrated example embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

Some example embodiments relate to technology that may block or prevent unauthorized use of copyrighted data in a learning process of a generative artificial intelligence (AI) model.

The example embodiments included in the disclosures herein may provide a learning-prevented creation as subtle perturbation is inserted into an original creation for a creation of which copyright is to be protected, and may block prevent the creation from being used without permission and learned by a generative AI model.

A learning prevention apparatus according to some example embodiments may be implemented by at least one computer device. A learning prevention method according to some example embodiments may be performed by at least one computer device included in the learning prevention apparatus. Here, a computer program according to an example embodiment may be installed and run on the computer device, and the computer device may perform the learning prevention method according to example embodiments under control of the computer program. The aforementioned computer program may be stored in a computer-readable record medium to implement the learning prevention method in conjunction with the computer device.

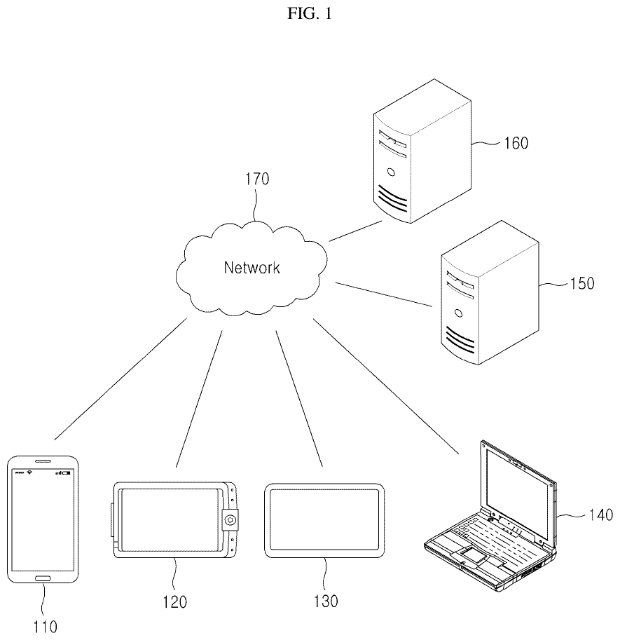

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 is provided as one example of environments applicable to the example embodiments and environments applicable to example embodiments are not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 each may be a smartphone, a mobile phone, a navigation device, a computer, a laptop computer, a digital broadcasting terminal, a personal digital assistant (PDA), a portable multimedia player (PMP), a tablet PC, or the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, and a broadcasting network.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service, for example, a content protection service, to the plurality of electronic devices 110, 120, 130, and 140 connected over the network 170.

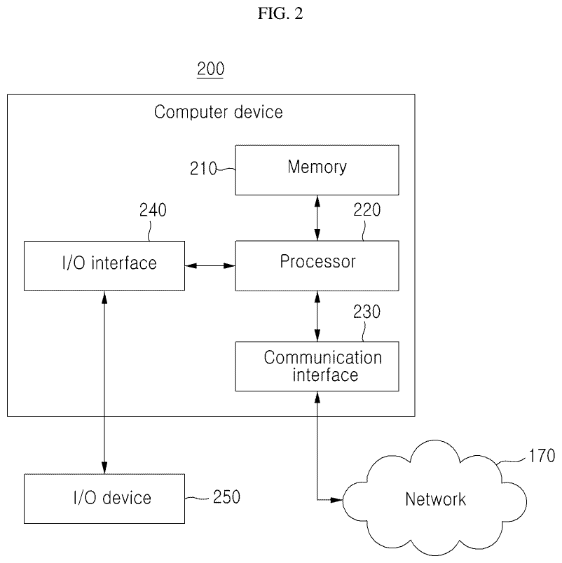

FIG. 2 is a block diagram illustrating an example of a computer device according to at least one example embodiment. Each of the plurality of electronic devices 110, 120, 130, and 140 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable recording medium. The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable recording medium separate from the memory 210. The other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and/or I/O operations. The computer-readable instructions may be provided by the memory 210 or the communication interface 230 to the processor 220. For example, the processor 220 may be configured to execute received instructions in response to a program code stored in a storage device, such as the memory 210.

The communication interface 230 may provide a function for communication between the computer device 200 and another apparatus (e.g., the aforementioned storage devices) over the network 170. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200. For example, a signal, an instruction, data, etc., received through the communication interface 230 may be forwarded to the processor 220 or the memory 210, and a file, etc., may be stored in a storage medium (e.g., the permanent storage device) further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to other example embodiments, the computer device 200 may include a greater or smaller number of components than the number of components shown in FIG. 2. However, there is no need to clearly illustrate most conventional components. For example, the computer device 200 may be configured to include at least a portion of the I/O device 250 or may further include other components, such as a transceiver and a database.

Hereinafter, a specific example embodiment of learning prevention technology to protect images is described.

A general learning prevention technology is based on an adversarial attack, which is to insert subtle perturbation into an image by tricking a deep learning model (classifier, detector, etc.) to malfunction in classifying or detecting the input image.

The learning prevention method blocks or prevents a copyrighted creation from being learned by generative AI, which may be similar to a method used in adversarial attacks in that subtle perturbation is inserted into an original image.

However, because a loss function used in adversarial attack technology is for image classification or detection and may not be used to block or prevent learning of generative AI, the example embodiment may design a new loss function to block or prevent learning of generative AI.

Also, the perturbation inserted to block or prevent learning has the disadvantage of being perceptually noticeable, so proposed herein is an additional module to insert perturbation that is not perceptually noticeable as much as possible.

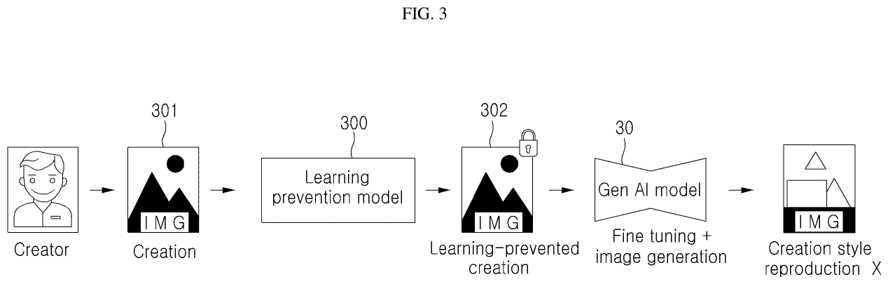

FIG. 3 illustrates an example of describing an overview of blocking or preventing learning of generative AI according to at least one example embodiment.

Referring to FIG. 3, a learning prevention model 300 is designed to block or prevent a generative AI model 30 from imitating a style of an image for which a creator has a copyright, and may create a learning-prevented creation 302 by inserting an adversarial perturbation into a creation 301 with the creator's unique style.

When the creation 301 is distributed in its original form, the creation 301 may be learned (e.g., fine-tuned) by the generative AI model 30, and the type of the creation 301 may be reproduced through the learned generative AI model 30.

On the other hand, when not the original creation 301 but the learning-prevented creation 302 for which learning is prevented through the learning prevention model 300 is used for learning of the generative AI model 30, the style of the learning-prevented creation 302 may not be reproduced using a fine-tuning technique.

Therefore, it is possible to protect the copyright of a creation through learning prevention technology that blocks or prevents imitation of a creator's unique style and to contribute to creating a desirable creative ecosystem by blocking or preventing copyrighted data from being used for learning of the generative AI model 30 without permission.

The processor 220 of the computer device 200 may be implemented as a component to perform the following learning prevention method. Depending on example embodiments, components of the processor 220 may be selectively included in or excluded from the processor 220. Also, depending on example embodiments, the components of the processor 220 may be separated or merged for functional representation of the processor 220.

The processor 220 and the components of the processor 220 may control the computer device 200 to perform operations included in the following learning prevention method. For example, the processor 220 and the components of the processor 220 may be implemented to execute an instruction according to a code of at least one program and a code of an OS included in the memory 210.

Here, the components of the processor 220 may be representations of different functions performed by the processor 220 in response to an instruction provided from a program code stored in the computer device 200.

The processor 220 may read a necessary or desired instruction from the memory 210 to which instructions related to control of the computer device 200 are loaded. In this case, the read instruction may include an instruction for controlling the processor 220 to perform operations that are described below.

Operations included in the learning prevention method may be performed in order different from the illustrated order. Some of the operations may be omitted or an additional process may be further included.

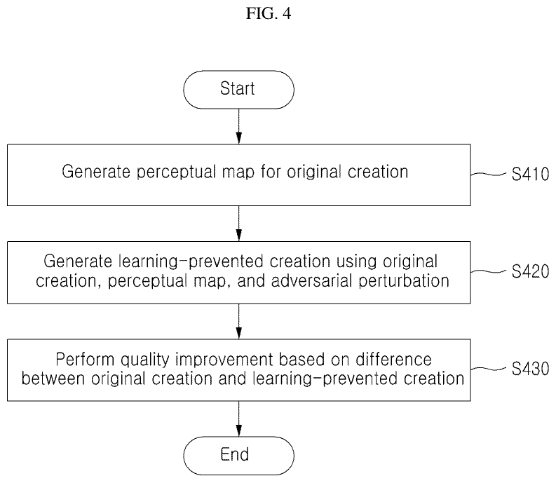

FIG. 4 is a flowchart illustrating an example of a method performed by a computer device according to at least one example embodiment.

Referring to FIG. 4, in operation S410, the processor 220 may generate a perceptual map for an original creation. That is, the processor 220 may calculate the perceptual map that represents perturbation sensitivity of (e.g., perceptual sensitivity to perturbation for) the original image to which learning prevention is to be applied. Operation S410 of generating the perceptual map is a preliminary work to utilize a perception-aware protection technique that relatively weakly applies learning prevention to a part (e.g., sky, simple texture, etc.) that is perceptually more sensitive to a small change (perturbation) and relatively strongly applies learning prevention to a part (e.g., bushes, complex texture, etc.) that is perceptually less sensitive thereto.

In operation S420, the processor 220 may generate a learning-prevented creation for the original creation using the perceptual map generated in operation S410 and adversarial perturbation. The processor 220 may generate the learning-prevented creation by inserting the adversarial perturbation for applying learning prevention into the original creation, and, here, may insert the adversarial perturbation into the original creation by considering the perceptual map corresponding to the original creation.

In operation S430, the processor 220 may improve quality of the learning-prevented creation based on a difference between the original creation and the learning-prevented creation generated in operation S420. As a method to make learning prevention results as perceptually as less noticeable as possible, the processor 220 may maintain the quality of learning prevention by calculating a perceptual similarity between the learning prevention results and the original creation and by using the same when updating a learning prevention model.

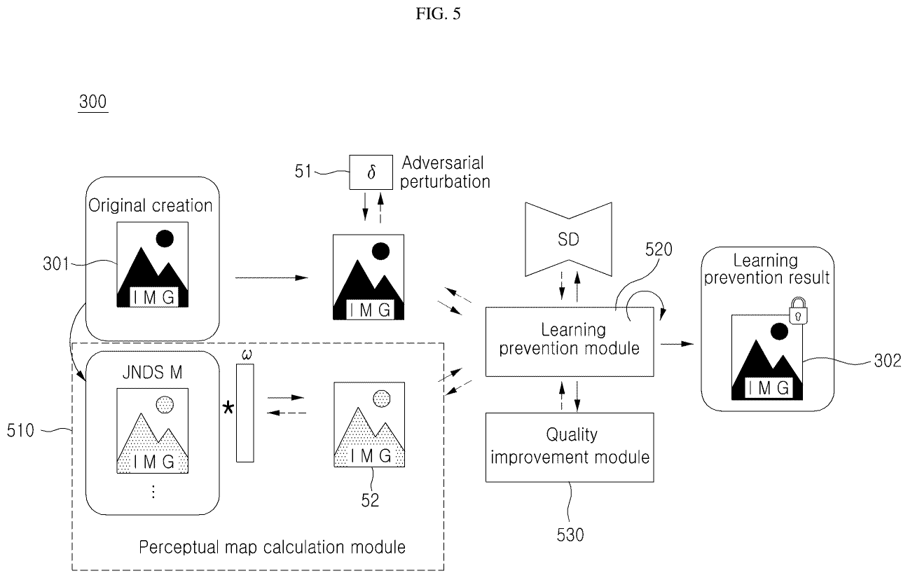

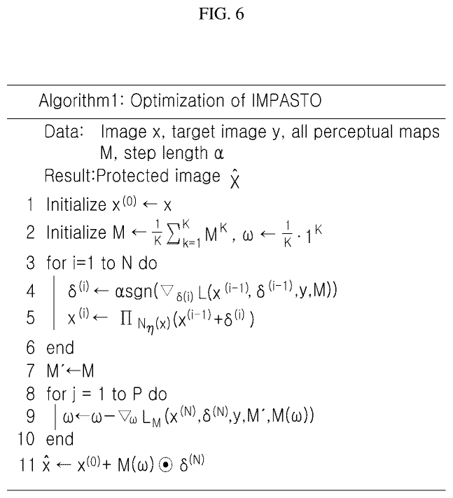

FIG. 5 illustrates an overview of a learning prevention model according to at least one example embodiment, and FIG. 6 illustrates an algorithm of a learning prevention technique according to at least one example embodiment.

Referring to FIG. 5, the learning prevention model 300 may include a perceptual map calculation module 510, a learning prevention module 520, and a quality improvement module 530.

The perceptual map calculation module 510 serves to calculate a perceptual map 52 that represents perturbation sensitivity of the original creation 301 to which learning prevention is to be applied (see lines 1 and 2 of FIG. 6).

The learning prevention module 520 serves to generate the learning-prevented creation 302 for the original creation 301 using the original creation 301, an adversarial perturbation 51, and the perceptual map 52 (see lines 3 to 11 of FIG. 6).

The quality improvement module 530 serves to maintain the quality of the learning-prevented creation 302 based on a difference with the original creation 301 (see loss function in line 4 of FIG. 6).

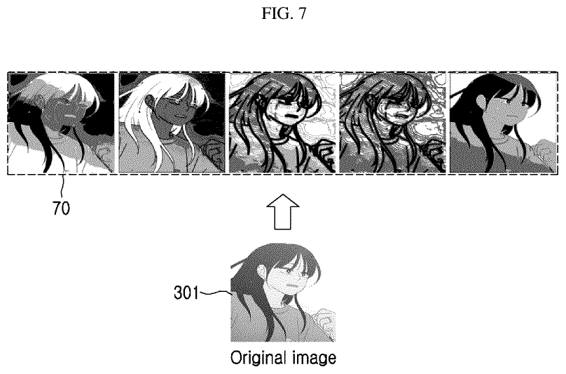

FIGS. 7 to 9 illustrate an example of calculating a perceptual map according to at least one example embodiment.

The example embodiment relates to using soft restriction strategy that applies learning prevention of various strengths in each region while protecting the entire image as much as possible for perception-aware protection and, to this end, introduces the perceptual map 52.

The perceptual map 52 reflects human sensitivity to a subtle change. For example, a value close to 1.0 represents a region with highest detection ability and a value close to 0.0 represents a region in which a change is most difficult to notice. Disturbance is suppressed in a region in which human's perceptual visibility is high, and the disturbance is amplified in a perceptually less noticeable region.

Referring to FIG. 7, if the original creation 301 is given, the perceptual map calculation module 510 may calculate a just noticeable difference (JND) image 70 using, for example, a JND, when calculating the perturbation sensitivity of the original creation 301.

Here, the term JND represents the minimum stimulus intensity (e.g., perturbation) desired to cause a noticeable change in visual perception. The purpose of a JND measurement model is to determine a perceptual threshold for each image pixel and its fundamental premise is to quantitatively represent human sensitivity to a subtle change in a visual region.

For example, the perceptual map calculation module 510 may generate the JND image 70 using at least two different techniques among luminance adaptation, contrast masking, contrast sensitivity function, image standard deviation, or entropy.

Luminance adaptation: Disturbance is less noticeable in a region with relatively very low or high brightness and is more noticeable in a medium lighting condition. Therefore, a fixed adaptive model may be used to modulate protection strength based on a pixel brightness.

Contrast masking: Disturbance smoothly blends into a region with complex texture, but leaves distinct trace on the flat surface. To mimic this, luminance contrast (or change) of a region may be used to measure pixel complexity.

Contrast sensitivity function: A frequency-based JND model is used by considering transmission characteristics of a human visual system. A human eye is sensitive to a signal of modulated frequency and exhibits insensitivity to a high-frequency component. Therefore, disturbance that crosses a high-frequency signal (e.g., edge) becomes less noticeable.

Image standard deviation: To evaluate the spatial structure of an image, standard deviation of an image block is calculated through inspiration by a structural similarity index (SSIM). It measures structural complexity of an image and is related to its susceptibility to subtle disturbance.

Entropy: Entropy of an image block is calculated to quantitatively represent an information amount or complexity in a local area.

The image standard deviation and the entropy technique may calculate local standard deviation and entropy of an image using, for example, a 9x9 filter.

The perceptual map calculation module 510 may generate a plurality of JND images 70 from the original creation 301 through different JND calculation methods. The aforementioned methods for JND calculation correspond to some example techniques and example embodiments are not limited thereto.

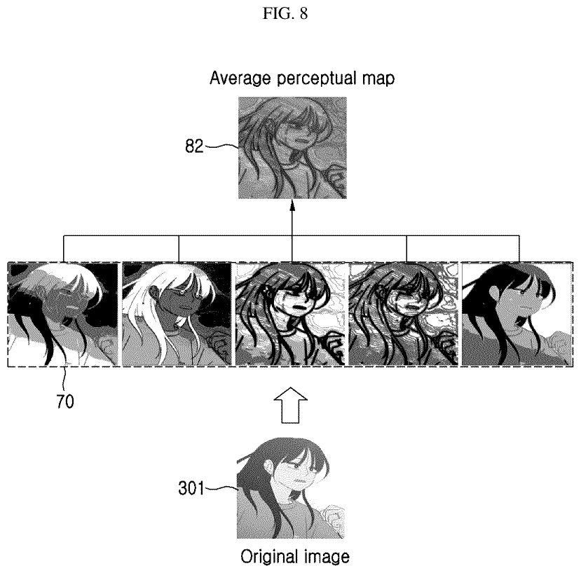

Referring to FIG. 8, the perceptual map calculation module 510 may generate a final perceptual map 82 by taking spatial averaging of the plurality of JND images 70. The perceptual map 82 according to the spatial averaging may be used to apply learning prevention.

Using the plurality of JND images 70 is better to using a single JND 70, but uniformly applying the average perceptual map 82 may not be optimal. Also, an optimal perceptual map for an image may variously change according to image structure and perturbation. Even in the same image, the detectability of perturbation may change depending on a disturbance type because the human sensitivity varies depending on a type of perturbation. To address this issue, the example embodiment may use a perceptual map based on instance-wise refinement (IWR) that adaptively defines the perceptual map for the original creation 301 (see loss function in line 9 of FIG. 6).

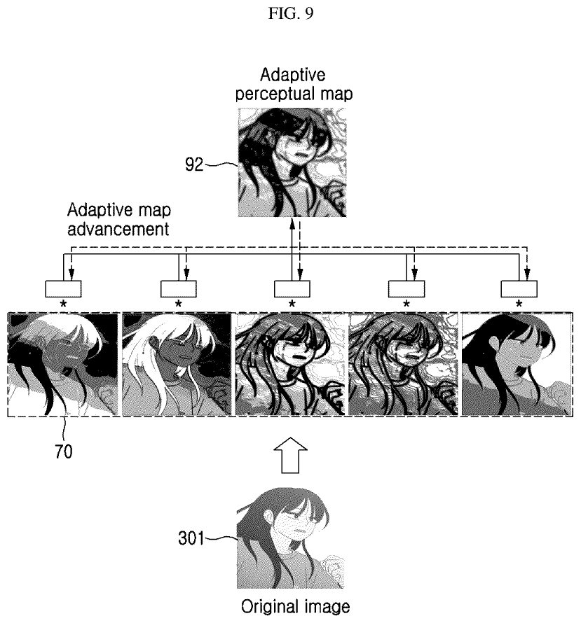

Referring to FIG. 9, the perceptual map calculation module 510 may generate an adaptive perceptual map 92 through a weighted sum that assigns different weights to the plurality of JND images 70. Here, a weight for each JND image 70 may be determined by or based on the original creation 301, and may be updated together in a process of updating the adversarial perturbation 51. Therefore, adaptive advancement of a perceptual map follows a weight learning method that applies high weights to various JND images 70 in order appropriate to the original creation 301 as shown in FIG. 9.

The learning prevention module 520 basically inserts the adversarial perturbation 51 δ into the original creation 301 and generates the learning prevented results corresponding to the learning-prevented creation 302. For example, a proses of generating the learning-prevented creation 302 may be achieved through a projected gradient descent (PGD) algorithm used in an adversarial attack task.

For example, the learning prevention module 520 may generate the learning-prevented creation 302 through an encoding-based method, and may update perturbation 8 through a stable diffusion (SD) encoder. This is to maximize a distance between an encoding expression of the original creation 301 and an encoding expression of the learning-prevented creation 302.

As another example, the learning prevention module 520 relates to updating the perturbation 8 according to guidance of a noise removal network (UNet), and here may update the perturbation 8 by maximizing the diffusion loss. Unlike general diffusion loss, a latent code may be extracted from the learning-prevented creation 302, and based on this, learning prevention performance and/or robustness may be improved.

The example embodiment may learn the perturbation 8 in a way that protects style imitation of the original creation 301 and also ensures the image quality of learning-prevented creation 302 as much as possible.

In the example embodiment, the learning prevention module 520 may generate the learning-prevented creation 302 using the given original creation 301 and the perceptual map 92. In a way that blocks or prevents learning well for the original creation 301, the adversarial perturbation 51 δ is learned. That is, the final learning-prevented creation 302 may be generated by repeatedly updating the adversarial perturbation 51 δ for applying learning prevention as shown in line 4 of FIG. 6 and by inserting the same into the original creation 301 (line 5 of FIG. 6). In particular, an adaptive map advancement method (lines 8 to 10 of FIG. 6) is used to consider the perceptual map 92 optimized for the original creation 301. In addition to the adversarial perturbation 51 δ, a weight of the perceptual map 92 may be learned to advance to a more perceptually less noticeable learning prevention technique.

The perceptual map 92 is improved through a weighted sum of the JND images 70. The weighted sum of the JND images 70 may be expressed as Equation 1.

$$M ( ω ) = {\sum }_{k = 1}^{K} {softmax ( ω )}^{k} * {M}^{k} \qquad [ Equation 1 ]$$

In Equation 1, ω denotes a learnable parameter as a weight that adjusts contribution of each JND. A weight for each JND image 70 for the original creation 301 may be optimized using the following objective function.

$${M}_{} = {‖ {SP}_{} ( x + {M}^{′} ⊙ δ ) - {SP}_{} ( x + M ( ω ) ⊙ δ ) ‖}_{2}^{2} + {( {\sum }_{i = 1}^{d} {\vert {M ( ω )}_{i} * {δ}_{i} \vert}^{p} )}^{1 / p} , \qquad [ Equation 2 ]$$

$$Here ,$$

$${SP}_{} = - {λ}_{ε} {ε}_{} ( x + δ , y ) + {λ}_{SD} {SD}_{} ( ε ( x + δ ) ) ,$$

$$and$$

$${SD}_{} = {z \sim E ( x ) , y , ϵ \sim N ( 0 , 1 ) , t}_{} [ {‖ ϵ - {ϵ}_{θ} ( {z}_{t} , t , c ( y ) ) ‖}_{2}^{2} ] .$$

$${λ}_{ε} and {λ}_{SD}$$

denote control parameters that allow traverse between the encoder and the UNet-based protection. At each time stage t, noise removal UNet ϵθ reconstructs the latent code z, that contains noise, if current time stage t and condition vector c(y) are given.

Here, M′ represents an initial perceptual map before an improvement stage. In Equation 2, the former term strengthens consistence of M by minimizing discrepancy in protection loss between the improved perceptual map M and the initial perceptual map M′. The latter term improves perceptual protection for a specific image. Lines 7 to 10 of FIG. 6 describe an adaptive map advancement procedure in detail.

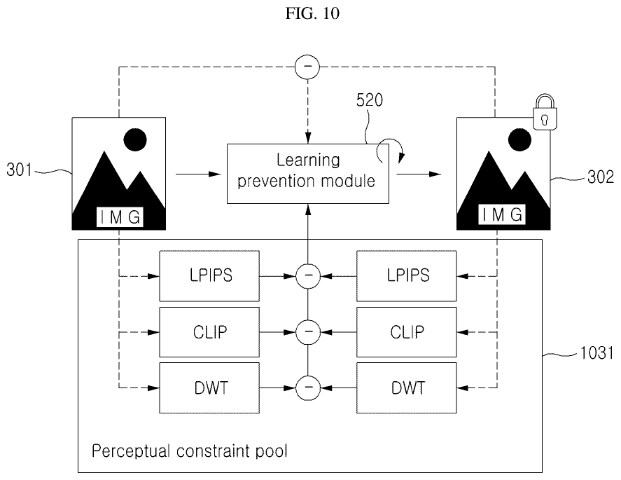

FIG. 10 illustrates an example of advancing the quality of a learning-prevented image according to at least one example embodiment.

Referring to FIG. 10, the quality improvement module 530 may use a perceptual constraint pool 1031 in various feature spaces to improve the perceptual quality of the learning-prevented creation 302. For example, the quality improvement module 530 may calculate a difference with the original creation 301 in the latent space by projecting the learning-prevented creation 301 onto the latent space through learned perceptual image patch similarity (LPIPS), contrastive learned image patch similarity (CLIP), and discrete wavelet transform (DWT) models. Here, the quality improvement module 530 may modulate the impact according to the constraint of the LPIPS model using the perceptual map 92. Masked constraint may provide relatively high image quality by focusing on a perceptually important region. The quality improvement module 530 may maintain image quality as similar as possible to the original creation within the perceptual constraint using the CLIP space. The CLIP constraint has the property of maximizing a feature distance between the learning-prevented creation 302 and a descriptive prompt. Also, the quality improvement module 530 may apply pixel-domain constraint that focuses only on low-frequency components according to perceptual protection motivation, and here may use DWT to enforce low-frequency filter-based constraint. To more closely match the learning-prevented creation 302 to human perception, the impact of loss on the DWT constraint may be adjusted using the perceptual map 92.

Although it is described that the perceptual constraint pool 1031 is constructed using the LPIPS, CLIP, and DWT models, it is not limited thereto and other latent models already released may be used. For example, the perceptual constraint pool 1031 may be configured with at least one (or one or more) of the LPIPS model, CLIP model, or the DWT model.

Therefore, through a quality improvement method using the perceptual constraint pool 1031, it is possible to improve the image quality of the learning-prevented creation 302 generated to block or prevent generative AI from learning the original creation 301.

As such, according to some example embodiments, it is possible to provide a learning-prevented creation by inserting subtle perturbation into an original creation to block or prevent unauthorized use of a creation in a learning process of a generative AI model. In particular, according to some example embodiments, by suppressing subtle perturbation that is inserted into an original creation as much as possible and by adjusting the perturbation strength based on perturbation sensitivity of the creation, it is possible to improve the quality of a learning-prevented creation without compromising a learning prevention performance.

The apparatuses described above may be implemented using hardware components, software components, and/or combination thereof. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of the processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, or a computer storage medium or device, to provide instructions or data to or being interpreted by the processing device. The software also may be distributed over network coupled computer systems such that the software is stored and executed in a distributed fashion. The software and data may be stored by one or more computer readable storage mediums.

The methods according to some example embodiments may be configured in a form of program instructions performed through various computer methods and recorded in non-transitory computer-readable media. Here, the media may continuously store computer-executable programs or may temporarily store the same for execution or download. Also, the media may be various types of recording devices or storage devices in a form in which one or a plurality of hardware components are combined. Without being limited to media directly connected to a computer device, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Also, examples of other media may include recording media and storage media managed by an app store that distributes applications or a site, a server, and the like that supplies and distributes other various types of software.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A learning prevention method of a computer device comprising at least one processor, the learning prevention method comprising:
generating, by the at least one processor, a perceptual map for an original image, the perceptual map representing perceptual sensitivity to perturbation for the original image; and
inserting, by the at least one processor, the perturbation into the original image based on the perceptual map to generate a result image for learning prevention.

2. The learning prevention method of claim 1, wherein the generating of the perceptual map comprises:
generating a plurality of just noticeable difference (JND) images through different JND calculation methods for the original image; and
generating the perceptual map for perception-aware protection using the plurality of JND images.

3. The learning prevention method of claim 1, wherein the generating of the perceptual map comprises:
generating the perceptual map for perception-aware protection using a plurality of just noticeable difference (JND) images, the plurality of JND images generated from the original image through different calculation methods; and
generating the perceptual map through a weighted sum of the plurality of JND images by assigning different weights to the plurality of JND images, respectively.

4. The learning prevention method of claim 3, further comprising:
determining each of the weights based on the original image, each of the weights being a learnable parameter that adjusts contribution of a corresponding one of the plurality of JND images.

5. The learning prevention method of claim 3, further comprising:
updating each of the weights is together in a process of updating the perturbation.

6. The learning prevention method of claim 1, wherein the generating of the perceptual map comprises:
generating the perceptual map for perception-aware protection using a plurality of just noticeable difference (JND) images, the plurality of JND images generated from the original image using different calculation methods; and
generating the perceptual map through spatial averaging for the plurality of JND images.

7. The learning prevention method of claim 1, wherein the generating of the result image for the learning prevention comprises generating the result image for preventing learning of a generative AI by inserting the perturbation into the original image according to the perceptual map.

8. The learning prevention method of claim 1, further comprising:
maintaining, by the at least one processor, quality of the result image based on a difference with the original image.

9. The learning prevention method of claim 8, wherein the maintaining of the quality of the result image comprises maintaining image quality similar to the original image within a perceptual constraint through a perceptual constraint pool configured with at least one latent model.

10. The learning prevention method of claim 8, wherein the maintaining of the quality of the result image comprises:
projecting the result image onto a latent space through a latent model; and
calculating a difference with the original image in the latent space.

11. A non-transitory computer-readable recording medium storing instructions that, when executed by a processor, cause a computer device including the processor to perform the learning prevention method of claim 1.

12. A computer device comprising:
at least one processor configured to execute computer-readable instructions and cause the computer device to,
generate a perceptual map for an original image, the perceptual map representing perceptual sensitivity to perturbation for the original image, and
insert the perturbation into the original image based on the perceptual map to generate a result image for learning prevention.

13. The computer device of claim 12, wherein the at least one processor is further configured to cause the computer device to,
generate a plurality of just noticeable difference (JND) images through different JND calculation methods for the original image, and
generate the perceptual map for perception-aware protection using the plurality of JND images.

14. The computer device of claim 12, wherein the at least one processor is further configured to cause the computer device to,
generate the perceptual map for perception-aware protection using a plurality of just noticeable difference (JND) images, the plurality of JND images generated from the original image through different calculation methods, and
generate the perceptual map through a weighted sum of the plurality of JND images by assigning different weights to the plurality of JND images, respectively.

15. The computer device of claim 14, wherein the at least one processor is further configured to cause the computer device to determine each of the weights based on the original image, each of the weights being a learnable parameter that adjusts contribution of a corresponding one of the plurality of JND images.

16. The computer device of claim 14, wherein the at least one processor is further configured to cause the computer device to update each of the weights together in a process of updating the perturbation.

17. The computer device of claim 12, wherein the at least one processor is configured to cause the computer device to generate the result image for preventing learning of a generative AI by inserting the perturbation into the original image according to the perceptual map.

18. The computer device of claim 12, wherein the at least one processor is further configured to cause the computer device to maintain quality of the result image based on a difference with the original image.

19. The computer device of claim 18, wherein the at least one processor is further configured to cause the computer device to maintain image quality similar to the original image within a perceptual constraint through a perceptual constraint pool configured with at least one latent model.

20. The computer device of claim 18, wherein the at least one processor is further configured to cause the computer device to project the result image onto a latent space through a latent model, and to calculate a difference with the original image in the latent space.
